(19) United States
(12) Patent Application Publication
(10) Pub. No.: US 2008/0074271 A1
(43) Pub. Date: Mar. 27, 2008

(54) Radio frequency transponders having three-dimensional antennas

(75) Inventor: Jan N. Hodges, Fernley, NV (US)

Correspondence Address: BANNER & WITCOFF, LTD., 1100 13th STREET, N.W., SUITE 1200, WASHINGTON, DC, 20005-4051, US

(73) Assignee: Science Applications International Corporation, San Diego, CA (US)

(21) Appl. No.: 11/527,568

(22) Filed: Sep. 27, 2006

(51) Int. Cl. G08B 13/14

(52) U.S. Cl. 340/572.7; 340/572.8

(57) ABSTRACT

Three-dimensional objects, such as product packages or gaming tokens, have formed thereon a three-dimensional antenna pattern coupled to a radio frequency transponder, such as an RFID tag. The antenna pattern permits signals from the transponder to be received regardless of the orientation or stacking condition of the objects. In one variation, a gaming token has formed thereon antenna portions on a top, bottom, and sides thereof, and a label having an RFID chip and antenna connectors is applied to the gaming token, thus coupling the RFID chip to the antenna that is formed around the gaming token.

### BACKGROUND

The invention relates generally to radio frequency transponders such as Radio Frequency Identification (RFID) tags having antennas for receiving and transmitting signals in close proximity thereof.

So-called RFID transponders or “tags,” which provide self-powered communication and data storage capabilities, are well known. The tags are small and can be attached to various articles such as documents, clothing, and articles to be sold (e.g., groceries or electronic equipment). Each tag wirelessly communicates with a transceiver (referred to as a reader) through a small flat antenna coupled to the tag and fixed to the article. The flat antenna and small size of the tag combine to provide a low-cost, non-intrusive yet highly accurate way to track individual articles. The reader transmits a signal that both powers the RFID tag (when received through the antenna) for the short period of time during which a microprocessor in the chip operates, and causes the RFID tag to transmit a response containing, for example, a unique identifier and/or other information stored in a memory of the RFID tag. The reader can use the received information in various ways, such as for inventory tracking purposes.

One known application for RFID tags is in the casino industry. Casinos are keenly interested in how many gaming pieces each gaming patron has won, lost, or has in his/her possession at a gaming table such as a blackjack table. For example, U.S. Pat. No. 5,651,548 describes a system for tracking gaming chips on casino tables through the use of antennas placed underneath the gaming tables. Each chip (e.g., in the form of a poker-chip sized circular token) has affixed thereto an RFID tag including a unique identification number, and an antenna (not shown) for communicating with antennas placed on the gaming table. The table-based readers query the chips to determine which (and how many) chips are present at each position at the table.

One difficulty with the system shown in the '548 patent is that when several chips are stacked on top of each other, the signals produced by chips blocked by other chips are decreased and can be missed, thus reducing reliability. This is caused primarily by the flat antennas on such chips, which are blocked by intervening chips and by metallic inserts sometimes used in casino chips. The blocking occurs not only in the vertically stacked direction but also when chips are stacked horizontally in troughs on the gaming tables. A decrease in ability to read the tags can also occur when the antennas on the chips are at a different orientation than the antennas on the readers.

Another application where RFID tags have widespread application is in inventory tracking, such as for groceries or electronic devices (e.g., televisions) coming off assembly lines. As in the casino application, however, it is difficult to read the tags in certain orientations or stacked situations, leading to a decrease in reliability.

U.S. Pat. No. 7,091,859 attempts to address some problems relating to stacking of rectangular containers having RFID tags, and describes a conductive structure having antennas on sides of containers, wherein the RFID tag signals are relayed from one container to another. That solution is directed to large cases, boxes and pallets, and it is doubtful that the structures therein would work with smaller-sized objects such as poker chips. Moreover, few details are provided regarding how antennas are coupled to the RFID tags.

### SUMMARY

One embodiment of the invention includes a radio frequency transponder having an associated antenna that is formed in a three-dimensional configuration around an object, such that at least three antenna portions extend along three perpendicular axes associated with the object. The object may comprise a hollow or solid parallelogram, cylinder, trapezoid, or any other three-dimensional shape.

Another embodiment of the invention includes a radio frequency transponder and a conductive material antenna formed over a planar surface of and around the circumference of an object, such as a circular gaming token, a coin, or a rectangular product package.

Another embodiment of the invention provides a radio frequency-enabled object having formed thereon a three-dimensional antenna that permits data from the object to be read in all orientations and aggregations of such objects.

Another embodiment of the invention includes a system for communicating with RFID transponders attached to objects having formed thereon three-dimensional antennas.

Yet another embodiment of the invention includes a method of forming a three-dimensional antenna around an object having an associated RFID transponder.

Still another embodiment provides a method of activating an object by applying an RFID-equipped label to the object such that conductors on the label electrically contact an antenna pattern formed around the object.

Yet another embodiment provides a gaming table having formed thereon a plurality of antennas arranged to receive signals from RFID-equipped gaming tokens, wherein the antennas are arranged at betting locations and coupled to a multiplexer that causes the antennas to be successively read.

Other variations and embodiments are described in more detail below, and the invention is not intended to be limited in any way by this brief summary.

### BRIEF DESCRIPTION OF THE DRAWINGS

FIG. 1A shows a three-dimensional orientation of a parallelogram object on which an antenna may be formed.

FIG. 1B shows a three-dimensional orientation of a cylindrical object on which an antenna may be formed.

FIG. 2A shows a top view of a cylindrical gaming token 200 constructed according to one embodiment of the invention.

FIG. 2B shows a bottom view of a cylindrical gaming token 200 with antenna portions 205 and 206 formed of conductive ink, foil, or similar techniques.

FIG. 3 shows a side view of a gaming token including an enlarged pad area 204b extending down the side of the circumference of the token.

FIG. 4 shows a label having conductive leads for coupling an RFID chip 401 to antenna elements on an object such as a gaming token.

FIG. 5 shows the label of FIG. 4 after it has been adhered to the gaming token of FIG. 2A.

FIG. 6 shows a plurality of stacked cylindrical gaming tokens having exposed antenna portions 204b on the sides of the tokens.

FIG. 7A shows a top view of a gaming token having an antenna portion 701 traversing the top of the token and four side segments 702 that traverse the sides of the token.

FIG. 7B shows a bottom view of the gaming token of FIG. 7A, including an antenna portion 703 traversing the bottom of the token, four side segments 706 that traverse the sides of the token, and two connection points 704 and 705 for connecting to an RFID chip (not shown).

FIG. 7C shows a side view of the gaming token of FIG. 7A.

FIG. 8A shows a top partial view of a gaming token having an antenna pattern formed thereon.

FIG. 8B shows a label with an RFID chip and leads to couple the RFID chip to the antenna pattern of FIG. 8A.

FIG. 8C shows a top view of a gaming token after the label and RFID chip of FIG. 8B have been applied to the top of the gaming token of FIG. 8A.

FIG. 8D shows a bottom view of the gaming token of FIG. 8A including an antenna pattern formed of three sections.

FIG. 8E shows a side view of the gaming token of FIG. 8A.

FIG. 9 shows one possible configuration of RFID reader antennas arranged on a blackjack table that can be used with gaming tokens according to one variation of the invention.

FIG. 10 shows details of one antenna of the embodiment in FIG. 9.

FIG. 11 shows an antenna array configuration that can be used for a 7-position blackjack table according to certain variations of the invention.

FIG. 12 shows a process including steps that can be carried out according to various principles of the invention.

### DETAILED DESCRIPTION OF THE INVENTION

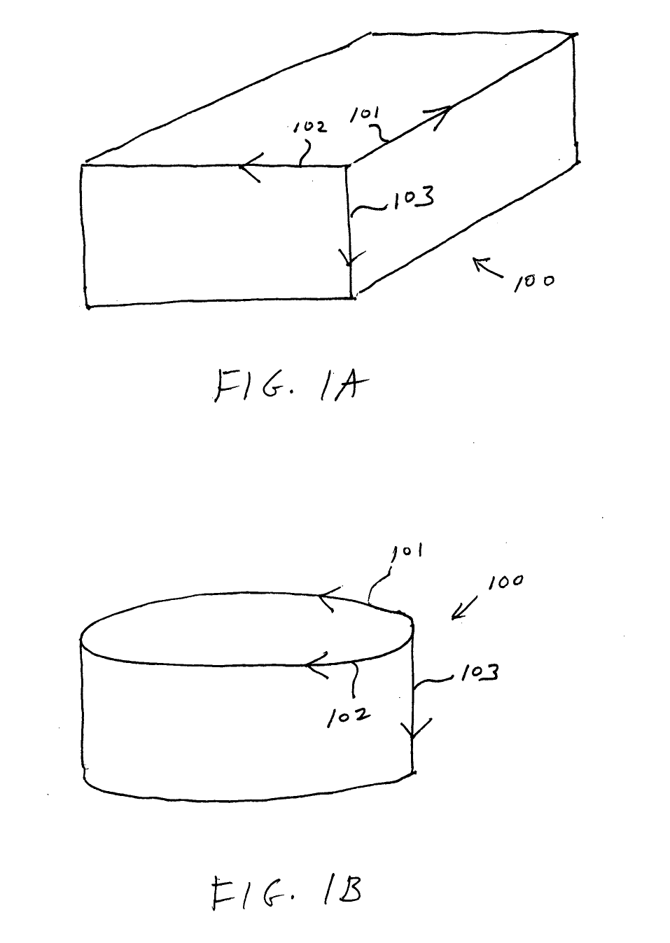

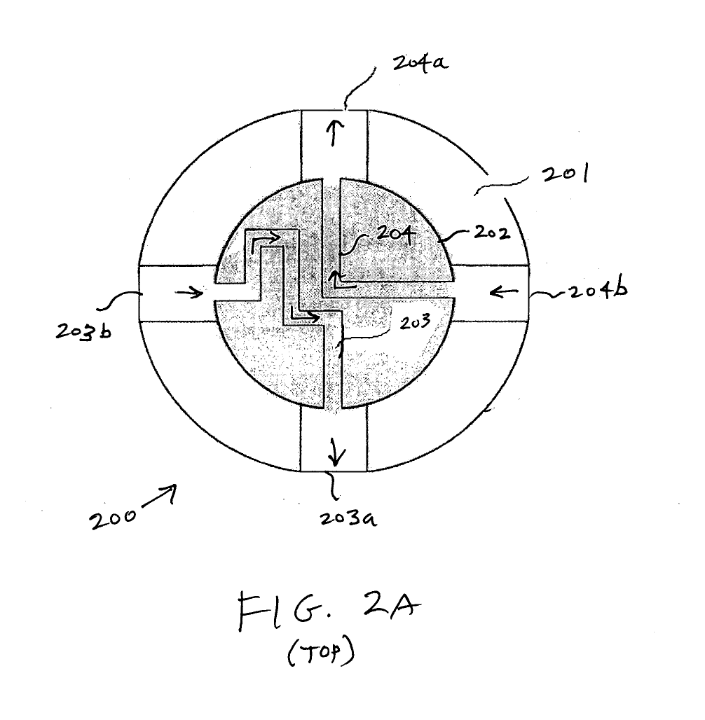

FIG. 1A shows a three-dimensional orientation of a parallelogram object on which an antenna may be formed according to certain aspects of the invention. In FIG. 1A, the object 100 comprises a rectangular shape, which may be hollow or solid. The object is oriented along three axes 101, 102, and 103, along which one or more antenna elements may be formed as described in more detail herein.

FIG. 1B shows a three-dimensional orientation of a cylindrical object on which an antenna may be formed according to certain aspects of the invention. In FIG. 1B, the object 100 comprises a generally cylindrical shape, which may be hollow or solid, and may comprise a gaming token of the type commonly used in casinos. The object is oriented in three dimensions 101, 102, and 103.

Although not shown in FIGS. 1A and 1B, antennas formed on other three-dimensionally shaped objects, such as a sphere or trapezoid, may also be provided according to the invention.

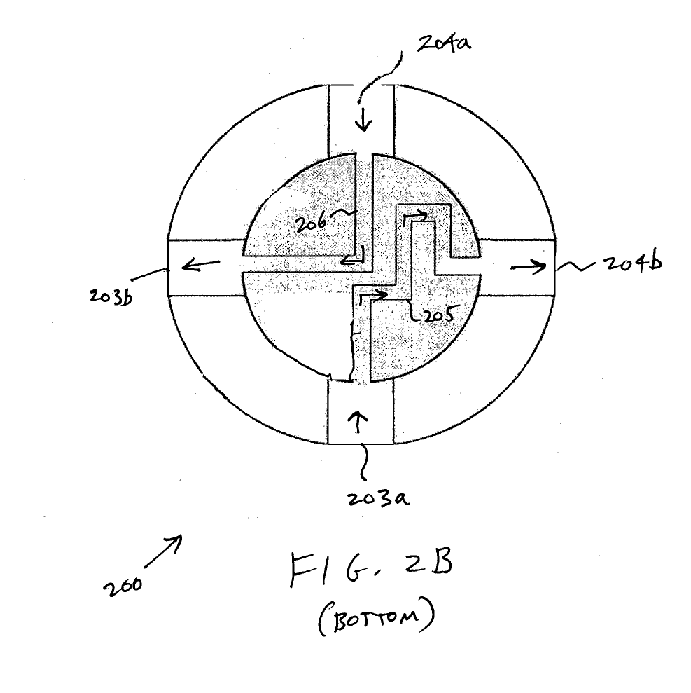

FIG. 2A shows a top view of a gaming token 200 constructed according to one embodiment of the invention. The token may be constructed of a solid plastic or clay-based composition known in the gaming industry (typically 1.5 inches in diameter and one-eighth of an inch thick), and may include a center portion 202 containing a logo and/or or other visible indicia (e.g., indicating a token value). Center portion 202 may comprise a metal foil as is known in the gaming industry.

According to one aspect of the invention, a first antenna portion 203 is formed along the two-dimensional top surface of the token using a conductive ink, metallic foil, lamination, silk-screening, or other similar technique. One possible conductive ink that can be used is made by Dow Corning: PI-2000 Highly Conductive Silver Ink, an organic polymer that can be used to print antenna patterns on the tokens and for reader antennas as described below. The antenna portions may alternatively be formed in the substrate of the object while the object is being formed. A second antenna portion 204 is also formed across a different area of the top of the token. Both the first and second portions form part of a loop with counterpart antenna portions formed on the sides and bottom of the token. For example, antenna portion 203 extends over the side of the token through enlarged pad areas 203a and 203b. Similarly, antenna portion 204 extends over the side of the token through enlarged pad areas 204a and 204b. If center portion 202 includes a foil insert, an insulator can be laminated over the metal portion to prevent contact with the metallic antenna portions. A protective sealant can be applied or laminated over the antenna patterns to protect them.

When the token is in the orientation shown in FIG. 2A, antenna portions 203 and 204 can pick up signals from an antenna placed above, below, or to the side of the token.

FIG. 2B shows a bottom view of a gaming token 200 with antenna portions 205 and 206 formed of conductive ink, stamped foil, or similar techniques as explained above. Antenna portion 206 extends through enlarged pad area 204a (which corresponds to pad area 204a in FIG. 2A on the reverse side of the token) and extends through enlarged pad area 203b (which corresponds to pad area 203b in FIG. 2A on the reverse side of the token).

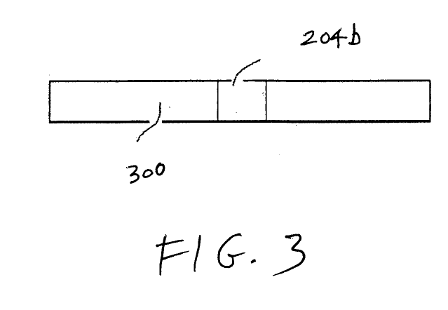

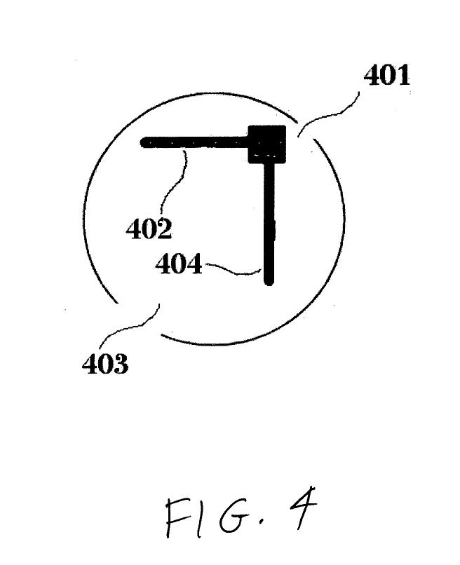

FIG. 3 shows a side view of gaming token 200, showing an insulated clay portion 300 and enlarged pad area 204b traveling down the side of the token. Although only one side of the cylindrical token is shown, enlarged pad areas 203a, 203b, and 203a are also included on each respective other side of the cylindrical token, such that all sides are covered. This permits signals reaching the token from any of the sides to be received, and in combination with the antenna portions on the top and bottom of the token, permits the token to be read from any angle and any orientation, regardless of stacking.

All four antenna portions 203, 204, 205 and 206 form part of a conductive loop that traverses both the top and bottom of the gaming token as well as the circumference of the gaming token. This can be seen through the arrows annotated in FIGS. 2A and 2B. As seen in FIG. 2A, one end of the antenna begins at enlarged pad area 203b and traverses the top of the chip, exiting at enlarged pad area 203a, which travels down the side of the gaming token and enters the bottom of the token (FIG. 2B) at area 203a, which travels across antenna segment 205 and exits at another side of the token at enlarged pad area 204b. The antenna loop continues from 204b down the side of the token and, after traversing the side of the token, re-enters the top surface of the token at enlarged pad area 204b (FIG. 2A), which flows through antenna element 204 and toward enlarged pad area 204a. From area 204a, the antenna loop continues down the side of the token (not shown) and re-enters the bottom surface at 204a (FIG. 2B), which flows across antenna element 206 and ends at enlarged tab area 203b.

For a standard 1.5-inch diameter chip of one-eighth inch thickness (average weight: 8.5 to 10 grams), the relative scale sizes of antenna segments shown in FIGS. 2A, 2B and 3 are exemplary for a system that uses a 13.56 MHz transmitting signal. However, antenna segments of wider or narrower widths may of course be used, and the invention is not limited in this respect. Antenna element patterns of different shapes may also be used (e.g., coils, more or fewer meandering loops, turns, or different angles) may also be used without departing from the inventive principles. For different frequencies, different antenna loop element configurations and lengths may also be used. In one embodiment, enlarged pad areas 203a through 204b may extend substantially along the side perimeter of the object such that they are formed along most of the sides of the object.

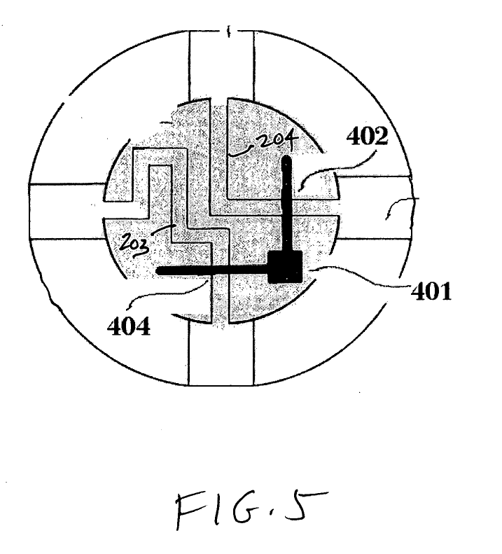

FIG. 4 shows a label having conductive leads for coupling an RFID chip 401 to antenna elements on an object, such as a gaming token. The label 403 has adhered thereto an RFID chip 401 and two conductive leads 402 and 404 coupled to the RFID chip. The conductive leads may be formed of metallic foil or conductive ink and coupled to the RFID chip in various ways, such as by soldering, strapping, staple or pressure contact. The conductive leads each connect to antenna ports on the RFID chip to permit RF signals to enter and exit the RFID chip. The conductive leads may include a pin or bump (not shown) to enhance contact with the antenna portions at the point of contact. The label with RFID chip and leads may be made using any of various methods such as those of the type disclosed in U.S. Pat. No. 6,929,412, entitled RFID Tag, Antenna, and Printer System. The label may be applied in various ways, such as using an adhesive, or by using heat and pressure.

Instead of forming the antenna on the surface of the object as shown in FIGS. 2A and 2B, the antenna may instead be formed on the label 403 and adhered to both or all sides of the object. In such a variation, the object may be formed with conductive ink or foil areas corresponding to enlarged tab areas 203a, 203b, 204a, and 204b (extending over the sides of the object), and then the label is applied, thus completing the antenna loop portions 203 and 204 by pressure with the tabs on the object.

In one embodiment, label 403 may be printed on the visible side with gaming indicia, such as colors, numbers, denominations, logos, and the like. In this manner, by applying the label to one side of a gaming token in FIG. 2A or 2B, the conductive leads 402 and 404 each respectively contact one end of the loop antenna illustrated therein, completing a circuit. Because the top label side is preprinted with various indicia such as a casino logo and chip denomination, affixing the label to the chip (which can be done by a machine) prepares the chip for use both aesthetically and functionally.

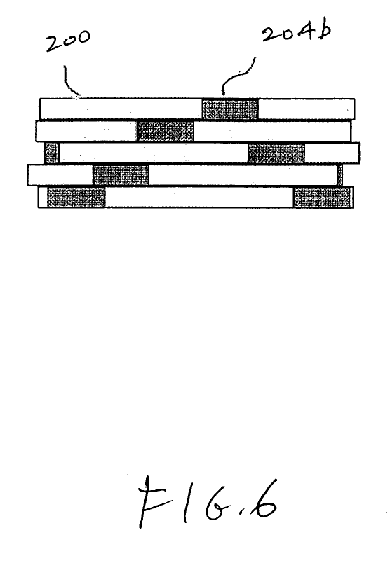

FIG. 5 shows the label of FIG. 4 after it has been adhered to the gaming token of FIG. 2A. As can be seen in FIG. 5, leads 402 and 404 contact respective antenna portions 203 and 204 and maintain electrical contact with those portions (thus completing the antenna circuit) by pressure of the label. The label will hide the RFID chip, the antenna leads and the antenna portions of the gaming token, thus making it aesthetically functional.

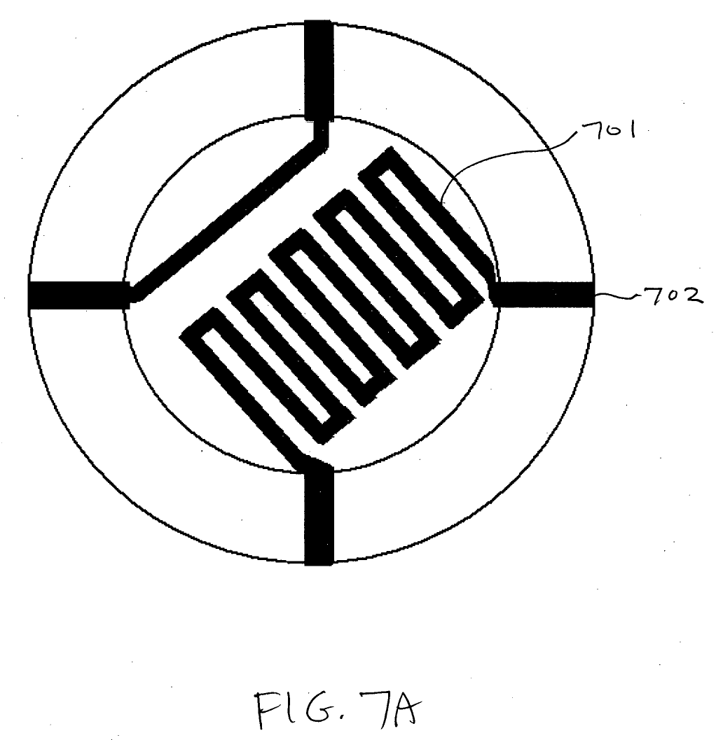

FIG. 6 shows a plurality of vertically stacked cylindrical gaming tokens having exposed antenna portions 204b on the sides of the tokens. As can be seen in FIG. 6, despite being stacked, each gaming token has multiple exposed antenna portions 204b formed along the sides of the solid cylindrical token. If the antenna is also printed on the sides of the tokens, transmission is also possible through chip-to-chip contact. Even if the tokens are stacked horizontally (on their sides, as might exist in a casino tray), each token has exposed antenna portions that can pick up signals from a radiating antenna placed upon a casino table.

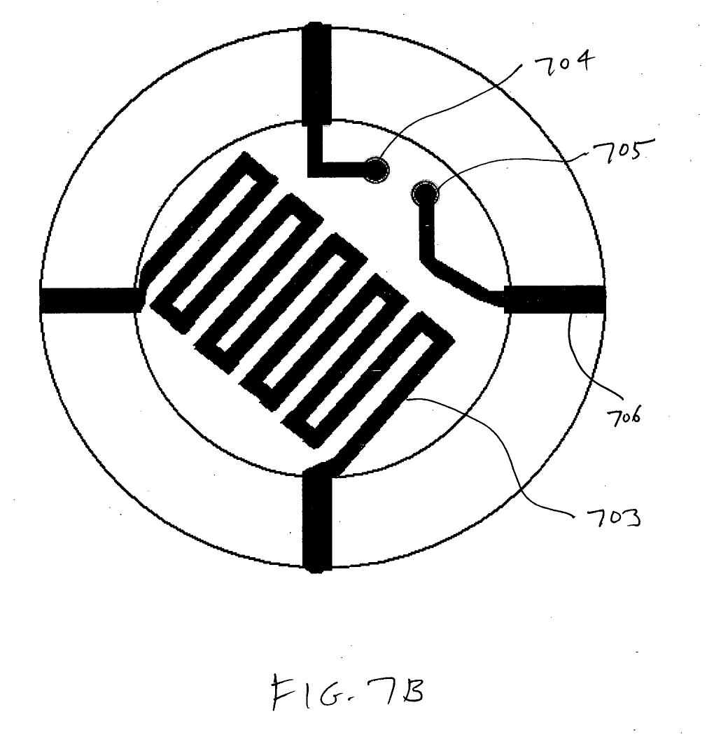

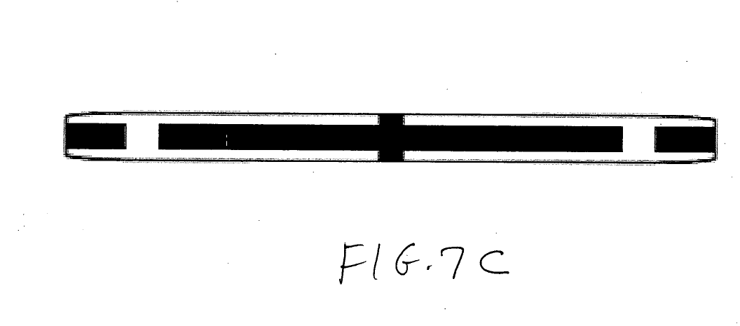

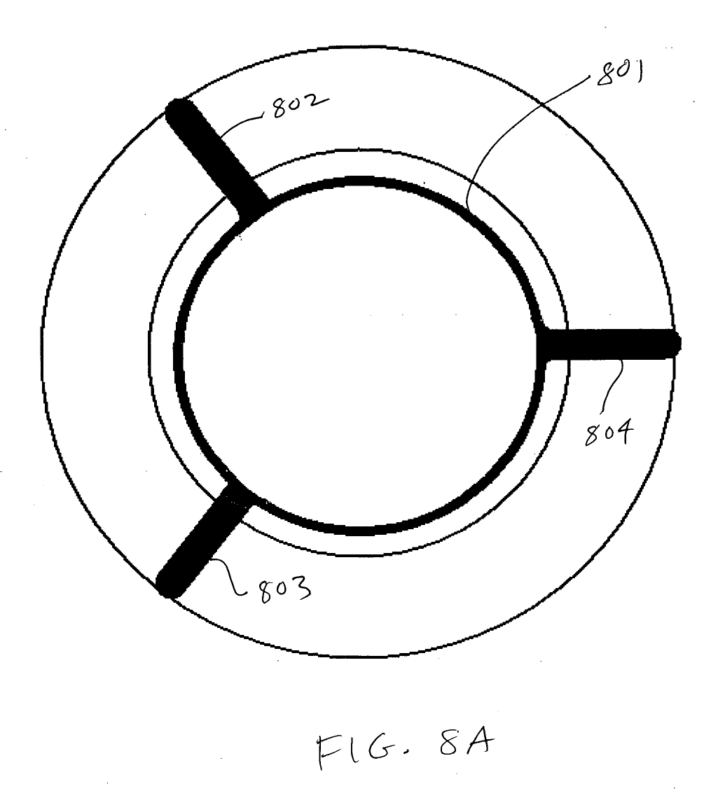

FIG. 7A shows a top view of a gaming token having an antenna portion 701 traversing the top of the token and four side segments 702 that traverse the sides of the token. This embodiment can be used with a 13.56 MHz antenna and may comprise a pattern of the type shown, or anything from a coil, loop, dipole, or variations thereof. The specific antenna pattern can be varied depending on the RFID chip and frequency used. The pattern can be printed onto an item such as a gaming token and activated by applying an RFID chip (such as described above, embedded in a label).

The IC chip handles any tuning that is required on the gaming chips; as long as the length of the antenna has not exceeded a maximum length, it will not resonate. The average length for 13.56 MHz is 9 to 18 inches; for 915 MHz, it is around 3 to 8 inches. Further antenna tuning (wake-up, attenuation, etc.) is provided by the readers with configuration software that is applied when the table is finished and put on-line.

FIG. 7B shows a bottom view of the gaming token of FIG. 7A, including an antenna portion 703 traversing the bottom of the token, four side segments 706 that traverse the sides of the token, and two connection points 704 and 705 for connecting to an RFID chip (not shown). The connection points 704 and 705 can be coupled to the RFID chip using the label described above, or through welding, soldering, strapping, stapling or other means.

FIG. 7C shows a side view of the gaming token of FIG. 7A. The side antenna patterns may be comprise of variations of a single conductive ink stripe, metal foil, etc. with separation of e.g., more than 1 centimeter between each. The specific width/dimensions may be varied depending on the RFID IC chip used.

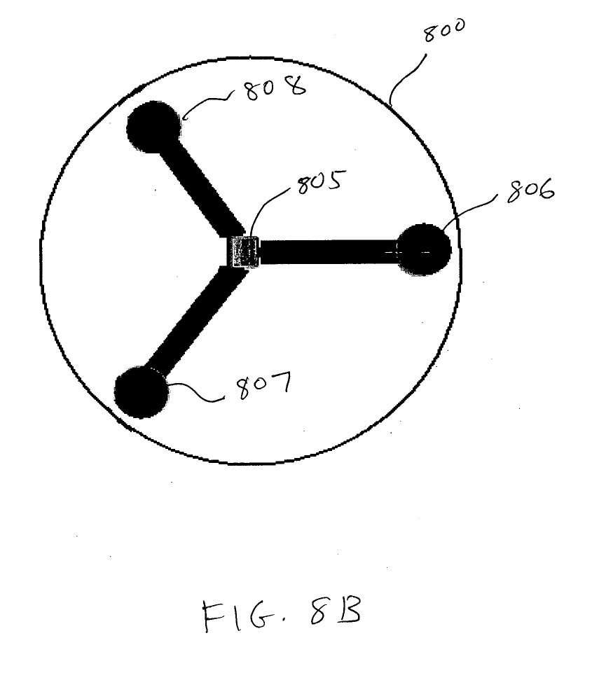

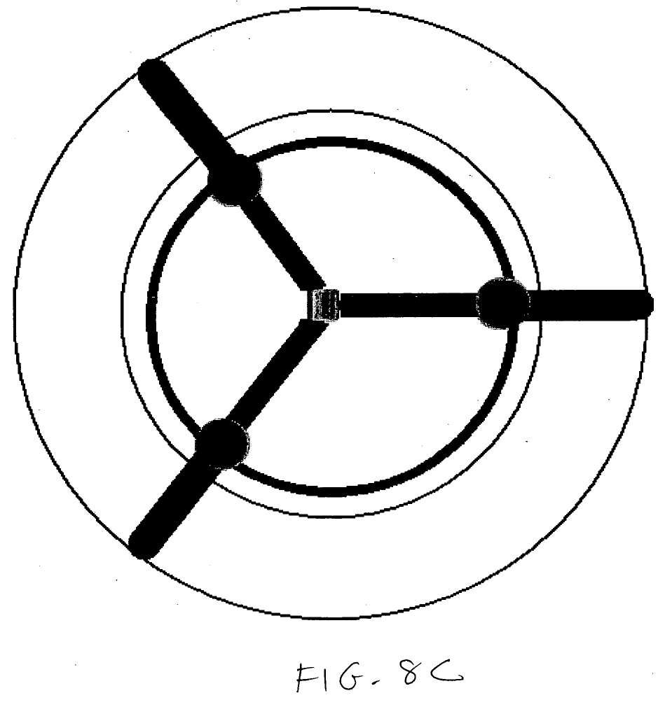

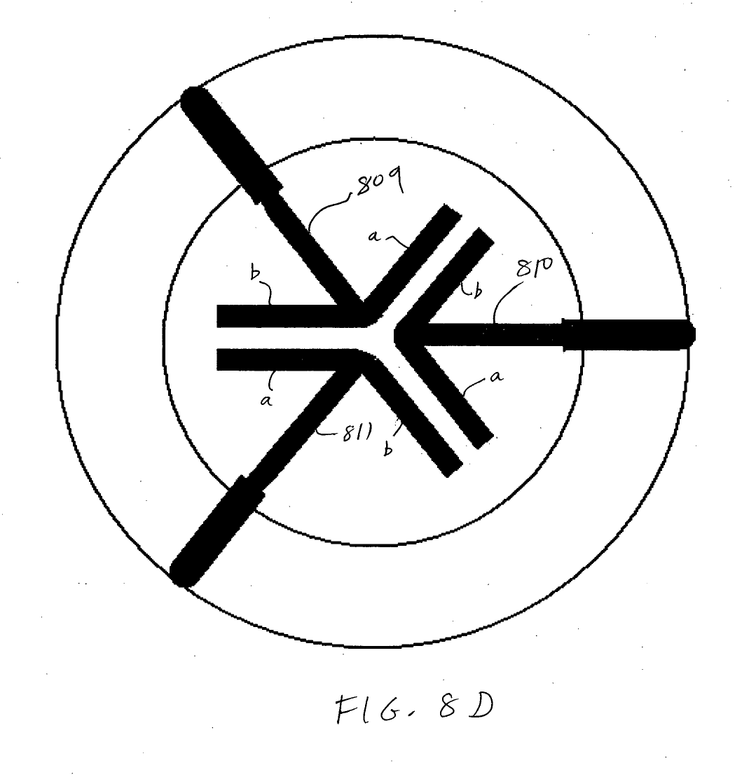

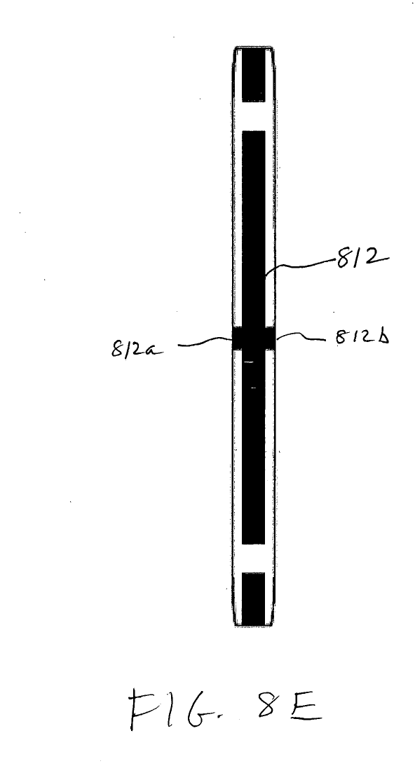

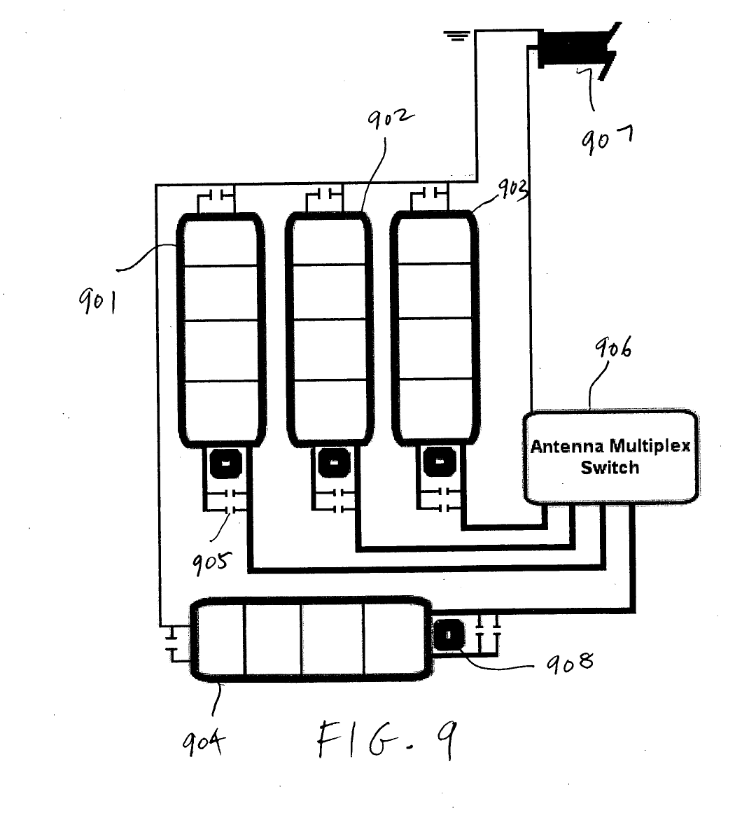

FIG. 8A shows a top partial view of a gaming token having an antenna pattern formed thereon. The pattern includes a circular portion 801 around the top of the token, which electrically connects to three leads 802, 803 and 804 that travel outward toward three respective sides of the token. This arrangement can be used for a 915 MHz frequency configuration.

FIG. 8B shows a label 800 with an RFID chip and leads to couple the RFID chip to the antenna pattern of FIG. 8A. The RFID chip 805 is in the center of the label and coupled to three leads 806, 807 and 808 that radiate outwardly and are intended to mate with circular portion 801 of FIG. 8A. When the label 800 is placed over the top of the token of FIG. 8A, the circular ends of leads 806, 807 and 808 make electrical contact with circular portion 801, thus joining the RFID IC chip to the antenna on the top and side portions of the token.

FIG. 8C shows a top view of a gaming token after the label and RFID chip of FIG. 8B have been applied to the top of the gaming token of FIG. 8A. One advantage of this embodiment is that due to the circular pattern 801, it may be easier to align the label with the top of the gaming token.

FIG. 8D shows a bottom view of the gaming token of FIG. 8A including an antenna pattern formed of three sections 809, 810 and 811. In this variation, each section has respective forked portions (a,b) extending away from the section at about a 45-degree angle. Other patterns can be used, such as curves and brackets to extend the length of the elements, as needed. Each section is also coupled to the side portions of the token as in the above-described embodiments.

FIG. 8E shows a side view of the gaming token of FIG. 8A, showing one side antenna portion 812 coupled to both the top and bottom through portions 812a and 812b.

As explained above, instead of printing the antenna portions on the gaming token or other object to which the inventive principles are applied, the antenna portions can be included on labels and applied to the gaming tokens.

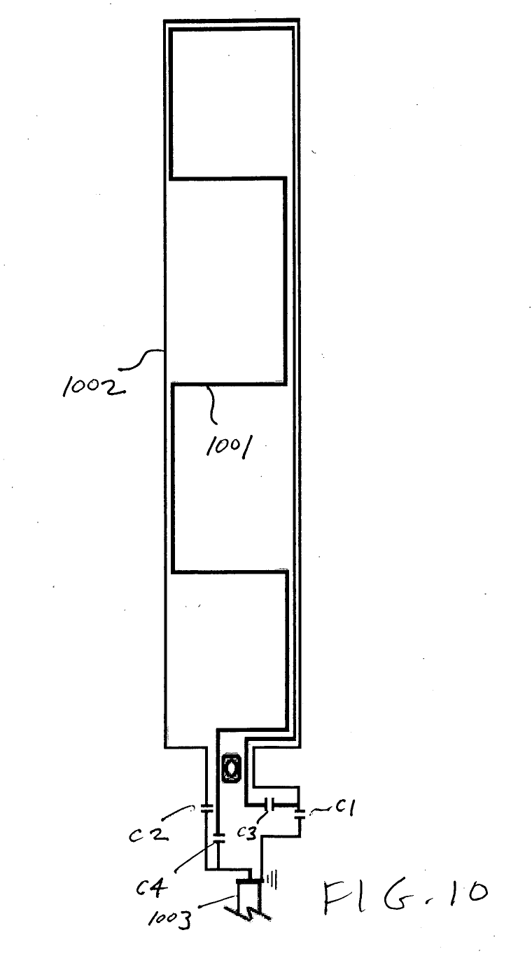

FIG. 9 shows one possible configuration of RFID antennas arranged on a blackjack table that can be used with gaming tokens according to one variation of the invention. The arrangement shown in FIG. 9 corresponds to a single player position and includes four antennas 901, 902, 903 and 904 each positioned under the felt or table at a particular position over which chips may be placed (for example, in the card circle, at a double-down location, at a chip stack for the player, etc). Each antenna may be formed on a substrate such as a plexiglass surface using conductive ink, foil, or wires, and may be tuned with capacitances 905 (only one shown in FIG. 9) to read specific zone widths and heights, when placed in conjunction with other antenna modules and orientations. An antenna multiplex switch 906 alternates among the antennas from RFID reader 907, such that each location is sequentially interrogated and tokens placed over each respective antenna respond to the interrogation. The antenna multiplex switch 906 activates each antenna module in sequence to provide an antenna ID and any RFID enabled item ID within its read area to the RFID reader 907. In this manner, the casino can determine how many chips of each denomination are located in each area in front of the player. Each antenna may include an identification RFID chip 908, providing identification for each antenna. All reader data can be filtered using commercially available software and sent to a host application database and application software.

The antennas may be located up to approximately 4 inches below the table, using a half-inch plywood table top. When gaming tokens are placed on the table over the antennas, stacked chips (whether stacked vertically or horizontally) radiate to each respective antenna when queried, providing a reliable readout of tokens.

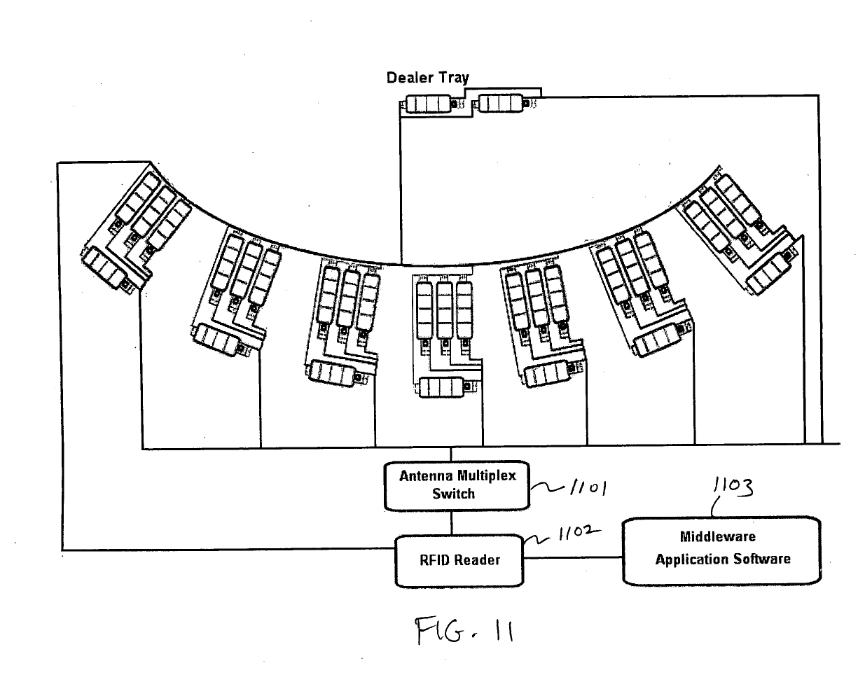

FIG. 10 shows details of one antenna of the embodiment in FIG. 9. The antenna includes a primary loop 1001 and secondary loop 1002, as well as various capacitors and a 75-ohm connection 1003 to a multiplex switch/reader. This antenna can be used for both 13.56 MHz and 915 MHz configurations. For 13.56 MHz one antenna at a time can be switched on by the multiplexer. For 915 MHz two can be switched on at a time in each player/dealer position, to allow for wake-up and command by the reader.

FIG. 11 shows an antenna array configuration that can be used for a 7-position blackjack table with dealer (30 antennas) according to certain variations of the invention. An antenna multiplex switch 1101 repeatedly cycles through the antennas on the table and the resulting RFID readings are provided to RFID reader 1102, which stores them in a middleware application software program 1103. As explained above, the readings (e.g., how many and what type of chips) are present at each position can be used for various purposes, such as determining which patrons are winning, losing, etc. The antennas can be printed on a plexiglass surface or mounted under a plywood table, or similar methods can be used. The antennas can be arranged at each player position so as to correspond to a betting circle, double-down area, or the like associated with a particular game being played—e.g., blackjack.

The inventive principles can be applied with various types of RFID chips, such as 64-bit chips or 96-bit chips. The new ISO 18000-6 RFID standard operating at 915 MHz allows read rates of 200 to 800 times per second with a high degree of uniqueness per chip. This increases the amount of data that can be stored on each chip (including manufacturer, date of manufacture, etc.), thus reducing the amount of data must be stored in a database. Any of various RFID chips can be used, such as those made by Impinj.

The principles described above can be applied to many different types of objects, and the invention is not limited to gaming tokens. For example, cereal boxes or other packages can be pre-printed with an antenna pattern such as that shown in FIG. 8A (e.g., using conductive ink during the box manufacturing process), and then a label containing an RFID IC chip and leads coupling to the antenna pattern such as that shown in FIG. 8B can be applied to the box as part of the manufacturing process, wherein portions of the antenna wrap around the box (e.g., printed using conductive ink). Accordingly, the invention includes a process for producing an RFID-enabled object by printing, embossing or impregnating the object with a three-dimensional antenna pattern that wraps around the object (e.g., around a cereal box) and then applying a label having an RFID tag and conductive connectors that connect the printed antenna on the object with the RFID tag.

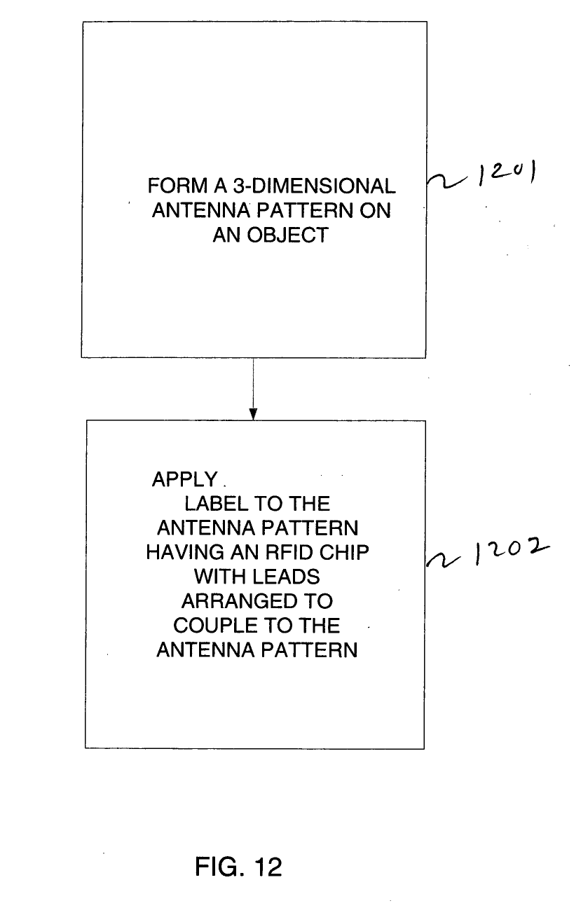

FIG. 12 shows a two-step process according to one variation of the invention. In step 1201, a three-dimensional antenna pattern is formed on an object, such as a package. In step 1202, a label is applied to the antenna pattern having an RFID chip with leads arranged to couple to the antenna pattern. This creates an RFID-enabled object having signal-bearing characteristics that permit the object to be read from any orientation or stacking condition.

What is claimed is:

1. An object having a first dimensional axis, a second dimensional axis, and a third dimensional axis, the object comprising a radio frequency transponder affixed thereto and an antenna coupled to the radio frequency transponder, wherein the antenna is formed around all sides of the object such that a first antenna portion is formed along the first dimensional axis, a second antenna portion is formed along the second dimensional axis, and a third antenna portion is formed along the third dimensional axis.

2. The object of claim 1, wherein the first dimensional axis is perpendicular to the second dimensional axis, and the second dimensional axis is perpendicular to the third dimensional axis.

3. The object of claim 2, wherein the object comprises a parallelogram, and wherein the first and second antenna portions cover part of a top and a bottom of the parallelogram, and wherein the third antenna portion covers part of a side of the parallelogram.

4. The object of claim 3, wherein the object comprises a rectangular product package.

5. The object of claim 1, wherein the object comprises a cylinder, and wherein the first and second antenna portions cover part of a top and a bottom of the cylinder, and wherein the third antenna portion covers part of an outer circumference of the cylinder.

6. The object of claim 5, wherein the object comprises a solid gaming token.

7. The object of claim 5, wherein the object comprises a solid coin.

8. The object of claim 1, wherein the antenna comprises a metallic ink applied to the object.

9. The object of claim 1, wherein the antenna comprises a metallic foil applied to the object.

10. The object of claim 1, wherein the radio frequency transponder comprises an RFID tag.

11. The object of claim 1, wherein the radio frequency transponder is coupled to the antenna by means of a label applied to the object.

12. The object of claim 11, wherein the label includes conductive leads that electrically couple the radio frequency transponder to the antenna.

13. The object of claim 11, wherein the antenna comprises a first loop portion traversing a top of the object, a second loop portion traversing the top of the object, a third loop portion traversing a bottom of the object, and a fourth loop portion traversing the bottom of the object, wherein at least two of the loop portions are coupled to each other around a side of the object through a conductive lead.

14. The object of claim 11, wherein the antenna comprises a first coil portion traversing a top of the object and a second coil portion traversing a bottom of the object, wherein the first and second coil portions are coupled through conductive portions traversing the sides of the object.

15. The object of claim 11, wherein the antenna comprises a circular pattern traversing a top of the object that is coupled to an antenna portion on the bottom of the object through conductive leads on the side of the object.

16. The object of claim 15, wherein the antenna portion on the bottom of the object comprises a plurality of conductive forked prongs radiating toward a center of the object.

17. A method of producing an RFID-enabled object comprising:
forming a three-dimensional antenna pattern on the object; and
applying to the object a label having adhered thereon an RFID chip and conductive leads leading from the RFID chip to positions corresponding to one or more points on the three-dimensional antenna pattern such that the RFID chip is in electrical communication with the three-dimensional antenna pattern.

18. The method of claim 17, wherein the step of forming comprises applying conductive ink to a surface of the object.

19. The method of claim 17, wherein the step of applying comprises applying an adhesive label to the object.

20. A method of activating an antenna formed on an object in three dimensions, comprising the step of applying to the object a label having adhered thereon a radio transponder device and conductive leads leading from the radio transponder device to positions corresponding to one or more points on a three-dimensional antenna pattern such that the radio transponder device is in electrical communication with the three-dimensional antenna pattern.

21. The method of claim 20, wherein the applying step is performed by applying an adhesive label to the object.

22. The method of claim 20, wherein the applying step is performed using heat and pressure to adhere the label to the object.

23. The method of claim 20, wherein the object comprises a cylindrical gaming token and the three-dimensional antenna pattern completely encircles the gaming token.

24. A gaming table configured to read signals from a plurality of gaming tokens placed thereon, comprising:
at each of a plurality of player positions, a plurality of antennas arranged to read signals from gaming tokens having radio transponders associated therewith, wherein each of the plurality of antennas at each player position is located under a corresponding game area associated with a game for which the gaming table is used; and
a multiplexing circuit that successively causes signals to be read from respective ones of the plurality of antennas.

25. The gaming table of claim 24, wherein each of the plurality of antennas is formed of conductive material adhered to a surface of the table.

26. The gaming table of claim 24, further comprising a second plurality of antennas arranged to read signals from gaming tokens having radio transponders associated therewith, wherein each of the second plurality of antennas is located under a dealer position on the gaming table.
